(19) United States
(12) Patent Application Publication
(10) Pub. No.: US 2009/0029583 A1
(43) Pub. Date: Jan. 29, 2009

(54) Touch-Safe Socket

(76) Inventor: Carsten H. Poulsen, Skive (DK)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 12/087,519

(22) PCT Filed: Jan. 18, 2007
(86) PCT No.: PCT/DK2007/000022

§ 371 Date: Sep. 17, 2008

(30) Foreign Application Priority Data
Jan. 20, 2006 (DK) PA 2006 00086
Mar. 22, 2006 (DK) PA 2006 00405

(51) Int. Cl. H01R 13/62

(52) U.S. Cl. 439/306

(57) ABSTRACT

A touch-safe socket having current-carrying poles (9) for receiving an electric article in particular has a plurality of sensors (13) mounted on its inner side, at least one of which is disposed axially displaced relative to the other sensors in the socket. The sensors are adapted to detect whether the electric bulb has been inserted into the socket, said sensors being connected to a relay circuit (7) which connects electric voltage to the current-carrying poles (9) of the socket when all the sensors (13) have detected that the electric bulb has been inserted into the socket. The sensors (13) may be magnetic sensors which detect metal from the threads of a bulb at a short distance from the metal.

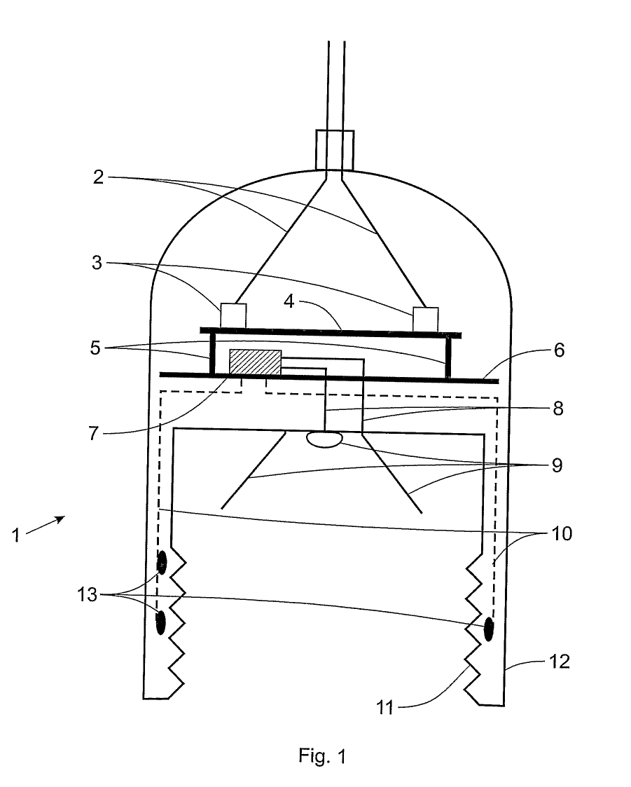

The invention relates to a touch-safe socket having securing means for securing an electric article, such as a bulb, in the socket, wherein the electric article is moved into the socket so that an inner side of the socket touches an outer side of the electric article, wherein at least two poles are mounted inside the socket, said poles being connected to a supply network, wherein the inner side of the socket is provided with sensors which are adapted to detect the presence of the material of which the outer side of the electric article is made, wherein the sensors are coupled to a relay circuit which is adapted to connect power to the poles when the sensors have detected the presence of the material, and wherein the sensors have a detection range which is smaller than half the diameter of the inner side of the threads.

Such a touch-safe socket is known from Danish Patent Application No. PA 2005 01590, which was not publicly available at the filing date of the present application.

This known socket is composed of movable parts, where the movement of the movable parts is established in that a threaded incandescent bulb is moved into the socket, whereby a movable bridge is first pressed into the socket, following which a movable carriage having poles are pulled in a direction out of the socket so as to establish electric connection to the poles of the bulb.

Further, DE 35 15 860 A1 discloses a touch-safe socket of the type defined in the introductory portion of claim 1, which has two sensors which are disposed in the same plane perpendicular to the longitudinal axis of the socket.

Accordingly, an object of the invention is to provide a touch-safe socket without movable parts which gives an even greater security against touch than known before.

The object of the invention is achieved by a touch-safe socket of the type defined in the introductory portion of claim 1, which is characterized in that at least three sensors are provided, and that at least one of the sensors is disposed axially displaced in the socket relative to the other sensors.

This ensures that it is impossible to apply a voltage to the socket if an electric article has not been inserted into it, also in the case where e.g. a child tries to insert a metallic object transversely into the socket.

A particularly expedient embodiment of the invention is, as stated in claim 2, that the inner side of the socket is formed by threads which are adapted to receive metal threads.

Expedient embodiments of the touch-safe socket is, as stated in claim 3, that the sensors are metal detectors which detect metal at a distance, or, as stated in claim 4, that the metal detector is a magnetic detector, or, as stated in claim 5, that the sensors are disposed near the bottom of the socket, or, as stated in claim 6, that the sensors are disposed axially displaced on the inner side of the socket.

The invention is implemented advantageously in connection with the electric article being a bulb which has metal threads, a bayonet coupling or a snap lock coupling, as stated in claim 7.

To control the voltage supply to the poles of the socket, it is expedient, as stated in claim 8, that the poles are coupled to the supply network via a circuit board on which the relay circuit is mounted.

The invention will now be explained more fully with reference to the sole FIGURE of the drawing.

This FIGURE schematically illustrates a touch-safe socket according to the invention, shown here as a socket which is designated 1 in its entirety in the FIGURE, for an incandescent bulb, an energy-saving bulb or the like.

The numeral 2 designates wires which are connected to a supply network (not shown), which typically applies a voltage between the wires of 110 volts or 220 volts at frequencies of 50 Hz or 60 Hz.

The wires 2 are connected to wire holders 3 by means of screws or clamping bushings (not shown).

The wire holders 3 are mounted on a mounting plate 4 which is carried by electric legs 5 standing on a circuit board 6. The electric legs are connected electrically to the wire holders 3 and the circuit board 6.

A relay circuit 7 is mounted on the circuit board 6. Wires 8 are connected to the relay circuit 7 and are also connected to poles 9 in the socket.

As will additionally be seen, the socket 1 has threads 11 which are intended to receive a bulb (not shown) in the form of an incandescent bulb, an energy-saving bulb or the like.

A plurality of sensors are arranged in the space between the threads 11 and the outer shell 12 of the socket; three sensors designated 13 are shown here. These sensors are connected to the relay circuit 7 via a wire bus 10.

As will be seen, two of the sensors 13 are disposed axially displaced relative to each other, while two other sensors are disposed on a circle having a plane which is perpendicular to the axial axis of the socket. The number of sensors and their location may be varied.

The sensors may e.g. be metal detectors which are constructed as magnets.

It is common to the sensors that they can only detect metal at a very small distance which is smaller than half the distance of the diameter of the threads 11,

It will then be explained how the touch-safe socket functions.

When a bulb is inserted into the threads, the sensors 13 detect the metal threads of the bulb, which causes a signal to be transferred to the relay circuit 7.

At the moment when all the sensors have applied their signal, the relay circuit 7 will allow voltage to be applied to the poles 8, which means that the bulb can emit light.

If the bulb is removed from the socket, the relay circuit will cut off the voltage to the poles as soon as just one of the sensors does not detect metal.

Thus, it is impossible to get an electric shock, e.g. if a child moves its hand into the socket. The same is the case if a child tries to move a metallic object into the socket, as all sensors then cannot detect at the same time that metal is preset, which is required if the relay circuit is to allow application of voltage between the poles 8.

1. A touch-safe socket (1) having an outer shell (12) accommodating a thread (11) and securing means for securing an electric article, such as a bulb, in the socket, wherein the electric article is moved into the socket so that the thread (11) touches an outer side of the electric article, wherein at least two poles (9) are mounted inside the socket, said poles being connected to a supply network, wherein the socket is provided with sensors (13) which are adapted to detect the presence of the material of which the outer side of the electric article is made, wherein the sensors are coupled to a relay circuit (7) which is adapted to connect power to the poles (9) when the sensors (13) have detected the presence of the material, wherein the sensors have a detection range which is smaller than half the diameter of the inner side of the threads, and wherein at least one of the sensors is disposed axially displaced in the socket relative to the other sensors, wherein three stationary sensors are provided and disposed between the outer shell (12) and the thread (11).

2. The touch-safe socket according to claim 1, wherein the threads (11) are adapted to receive metal threads.

3. The touch-safe socket according to claim 1, wherein the sensors (13) are metal detectors.

4. The touch-safe socket according to claim 3, wherein the metal detector is a magnetic detector.

5. The touch-safe socket according to claim 1, wherein the sensors (13) are disposed near the bottom of the socket.

6. The touch-safe socket according to claim 1, wherein the sensors (13) are disposed axially displaced on the inner side of the socket.

7. The touch-safe socket according to claim 1, wherein the electric article is a bulb which has metal threads, a bayonet coupling or a snap lock coupling.

8. The touch-safe socket according to claim 1, wherein the poles (9) are coupled to the supply network via a circuit board (6) on which the relay circuit (7) is mounted.
